(19) United States
(12) Patent Application Publication
(10) Pub. No.: US 2009/0174352 A1
(43) Pub. Date: Jul. 9, 2009

(54) Computer Controlled Brushless Synchronous Motor

(76) Inventor: Adam Lockhart, Dallas, TX (US)

Correspondence Address: WILSON DANIEL SWAYZE, JR., 3804 CLEARWATER CT., PLANO, TX, 75025, US

(21) Appl. No.: 12/349,291

(22) Filed: Jan. 6, 2009

Related U.S. Application Data
(60) Provisional application No. 61/010,271, filed on Jan. 7, 2008.

(51) Int. Cl. H02P 6/14; H02K 29/06; H02K 21/12

(52) U.S. Cl. 318/400.26; 318/400.37; 310/156.01

(57) ABSTRACT

A brushless synchronous motor includes a controller producing a plurality of current vectors having different directions, applied to the synchronous motor. The synchronous motor control system includes a sensor for sensing the rotational angle of a synchronous motor, and a computer for generating data describing a plurality of current vectors corresponding to the rotational angle sensed by the sensor. The computer interfaces with a plurality of digital to analogue conversion circuits generating a plurality of control signals. The control signals are applied to amplification circuitry thereby generating a plurality of current vectors to supply the stator coils of the motor. The motor includes two sections of stator coil arrangements; one is arranged interior to the permanent magnets of the rotor, and one is arrange exterior to the rotor.

### PRIORITY

The present invention claims priority and 35 USC section 119 based on provisional application with a Ser. No. 61/010,271 which was filed on Jan. 7, 2008.

### FIELD OF THE INVENTION

The present invention relates to an electric motor and controller, and more particularly, to a DC brushless synchronous motor and a computer controller.

### BACKGROUND

A DC brushless synchronous motor typically includes stationary electromagnetic windings, and permanent magnets affixed to the rotor. The present invention necessitates a motor that includes a position sensing apparatus to determine rotor position. The control system dynamically determines the amount of electrical current in each stator coil. These stationary coils provide the impetus to displace permanent magnets, causing rotor torsion.

There have been many varying designs for this type of motor. Many of these variations require and employ controllers that benefit the design of the motor. Controllers are paired with motors to maintain advantages over the specific application of the motor.

Among these many designs of synchronous motors, there are two kinds of rotor designs: internal rotor and external rotor. Internal rotor designs have permanent magnets affixed to the rotor, surrounded by stator coils. External rotor designs have the permanent magnets rotating around an inner arrangement of stator coils.

The rotor is constrained by a rotational axis. Force exerted on the rotor is directed by said axial constraint. The axis bears all friction from this force, and provides a path of least resistance allowing the rotor to rotate. In a typical internal rotor synchronous motor, the permanent magnet poles are aligned along a rotational radius. North or south are at the outermost end of the radius. The angle to which this radius is offset from a stator coil, or the torque angle, at any given time makes variant the angle of electromagnetic force exerted on the pole. The effective force creating torque is a trigonometric function of the torque angle and may be defined by the following equation:

T=T_{MAX}*sin(d)

This is an equation for torque where T_{MAX} is the maximum torque that can be produced by a given current. This equation may be used for an explanation of a simple electric motor but can be used to demonstrate the interaction between one stator coil and one rotor pole. In prior art electric motors, when the stator and the rotor poles are aligned (torque angle d=0 degrees) no torque is produced. Magnetic field strength is greatest closest to the magnet and is concentrated at the poles. Therefore, in prior art motors the condition whereby the most electromagnetic force may be created, where stator and rotor poles are aligned and closest together, there is absolutely zero torque created. This will be referred to as problem one.

Early synchronous motors were known to be problematic in terms of starting conditions. They could rotate in either direction upon starting, depending on the relative at-rest position of the rotor and stator. The motor would not turn upon starting if the rotor were in a balanced condition where the forces that tend to move the rotor are equal on either side. In prior art motors, these problems have been addressed by creating asymmetrical conditions between rotor and stator poles. A number of stator poles would be misaligned to create asymmetrical conditions for starting. This practice had a negative effect on running torque, as it sacrificed a portion of the stator for ideal starting conditions. The starting conditions of synchronous motors will be referred to as the second problem.

With any electric motor, horsepower may be determined in time intervals. These intervals indicate the amount of time a motor can maintain the power output safely without causing any damage to the motor. The damage is a result of heat created by motor coils. This will be the third problem addressed.

Synchronous motors generally employ a rotor having a plurality of magnetic poles. The arrangement of these poles is a result of positioning a plurality of permanent magnets having north and south poles, such that only one pole interacts with the stator coils. Each permanent magnet adds mass to the rotor, yet only half of it is utilized. This inefficient use of rotor mass will be addressed as problem four.

### SUMMARY

A DC brushless synchronous motor and controller may include a detection circuit for detecting a rotational angle of the rotor of said synchronous motor, a calculating circuit for calculating data corresponding to a plurality of control signals based upon the rotational angle coupled to said detection circuit, a control signal generating circuit for generating a plurality of control signals by converting digital information into analogue control signals, a current vector generating circuit for generating a plurality of current vectors by amplifying said plurality of control signals and a synchronous motor drive circuit. Each of said plurality of current vectors may be applied correspondingly to each stator coil of said motor.

The calculating circuit may include a computer with a program memory having stored therein a computer program in order to facilitate the calculation and transmitting of data, and the control signal generating circuit may include a plurality of digital to analogue conversion circuits to generate the plurality of control signals.

The calculating circuit may include a data interface for communicating data to a plurality of digital to analogue converters, and the current vector generating circuit may include a plurality of amplification circuitry to generate the plurality of current vectors based upon the control signals.

The synchronous motor drive circuit may include a rotor being affixed to a plurality of permanent magnets by rotating along a circular path.

The permanent magnets may travel along an exterior of internal stator coils and along an interior of external stator coils, and each of a plurality of permanent magnets may include a magnetic pole actuated by internal stator coils and an opposing magnetic pole actuated by external stator coils.

The current vector may be connected to supply an internal stator coil.

### BRIEF DESCRIPTION OF THE DRAWINGS

The invention may be understood by reference to the following description taken in conjunction with the accompanying drawings, in which, like reference numerals identify like elements, and in which:

FIG. 1 is a cross-sectional view of the rotor and stator coil arrangement.

FIG. 2A is a view of a rotor arm and permanent magnet, and FIG. 2B is a side view of a rotor arm and permanent magnet.

FIG. 3 is a portion of the cross-sectional view illustrating drive means.

FIG. 4A is a view of front rotor assembly, and FIG. 4B is a side view of front and rear rotor assembly coupling.

FIG. 5A is a view of rear rotor electrical conduit, and FIG. 5B shows rear rotor conduit with partial rear rotor assembly.

FIG. 6 is a generalized schematic of data interface and the circuitry for a single stator coil;

FIG. 7 illustrates a calculation circuit of the present invention.

### DETAILED DESCRIPTION

The teachings of the present invention are designed to be used with either a small motor or a large electric motor. The present invention may be used with transportation and industrial applications or other appropriate applications. The current motor applications are presently in need of efficient design with high power output. These are applications where internal combustion motors may dominate even though they are inefficient, create emissions and exhaust natural resources. Electric power may also be obtained from less expensive renewable energy sources such as: solar, hydroelectric, geothermal, wind-generated, and solar thermal. Currently, automobiles that run primarily on electric power may operate on roughly 25 percent of the cost of gasoline and diesel motors.

The present invention could be used in other applications where precise control is beneficial. The motor controller could be beneficial for other motor designs, such as servomotors for robotics requiring precision. The present motor design may relate to small motors, large motors and may be well suited as an extremely large motor. The design necessitates that there be appropriate spatial distance between components to avoid conflicting electromagnetic actuation which may eliminate the applicability to very small motors.

There are further potential advantages of a motor with a computer controller, which extend to any advantages of a computer system. Presently, automobiles that utilize electric motors may include a computerized user interface through which one may monitor energy consumption and power reserves. The user interface can be integrated into the computer system included in the present invention. With additional sensors, the computer could monitor heat to protect the motor. Transportation of cargo could be optimized, calculating cargo weight as a motor control variable. A computer controller has the potential to limit excess energy consumption to ensure that a destination is within reach.

The computer controller included in the present invention is a flexible design. It is intended as a controller that may be implemented in many types of synchronous motor designs. This motor provides for the complexity of the separate arrangements of numerous stator coils. The plurality of stator coils to be individually controlled is not confined to a specific number, nor is the plurality of permanent magnets affixed to the rotor. The distribution of permanent magnets is intended to be near even and symmetrical.

Synchronous motor controllers typically employ rectifiers, sine wave oscillators, square wave oscillators, pulse width modulation circuits and other types of circuits. The controller included in this invention maintains the ability to emulate almost any waveform; however, the design of the motor shown may have current in one direction. If the controller were implemented in a different motor design, then the circuitry could easily be designed to provide alternating current. Furthermore, the computer controller has the potential to optimize efficiency through computer analysis. In the process of programming the computer controller by computer programming language, information can be gathered to determine details regarding energy consumption and torque output. Analysis of this information can be used to determine an algorithm providing near maximum efficiency. The major advantages of the computer controller may include: programmability and re-programmability.

In addition to the computer controller design, this invention pertains to an improvement in rotor design. It is an internal or/and external rotor. It is intended to rotate in a manner such that the inner coils are pulling the permanent magnets and the outer coils are pushing the magnets along their path which may be circular.

The solution to problem one in this invention may include angling permanent magnet and electromagnet poles such that the force created when stator and rotor poles are aligned and closest together; the resulting torque produced utilizes a majority of the force created. As described previously, a force perpendicular to the rotational radius creates substantially the most torque (T_{MAX}*sin 90). If the force were skewed, for example, at a 45-degree angle (T_{MAX}*sin 45), then almost 71 percent of the force is used to produce torque, as opposed to substantially zero percent (T_{MAX}*sin 0). The previous equation describes torque in simple terms for a small motor. The equation makes an assumption that the stator pole is large enough and rotor is small enough that the electromagnetic force is created in the same direction no matter the angle of the rotor. It is adequate to convey problem one; however, a large motor involves further mathematic complexity. A similar equation describes, in at least two planes, the torque created on an axis by a given force acting at an angle on a radius of said axis.

T=r*F*sin Θ

In this equation, the length of the radius r determines the leverage that force F will have on the resulting torque. The function of the radius length on torque shows that a larger radius or rotor creates more torque. While doubling the radius may double torque, it also doubles the circumferential distance the magnet will have to travel, sacrificing RPM. Because the range of the sine function is zero to one, the angle Θ determines the percentage of maximum force possible from r*F that creates torque. The angle in prior art large motors is still zero when rotor and stator poles are aligned and closest together. The difference between this and the previous equation is that in a large motor Θ is not the angle d to which the rotational angle of the rotor is offset from the stator. Because the rotor is larger than the stator pole, the angle Θ is the degree to which the stator pole becomes skewed from the rotor pole radius. It is a function of rotational angle d but is affected by width of magnetic poles and length of radius. Therefore, an angle Θ of b 45 degrees will occur in prior art large motors where the angle d is much smaller than 45 degrees.

This solution to problem one does not indicate that the skewing of rotor and stator poles creates a condition whereby force created is skewed. As described, said condition occurs in prior art motors when poles are misaligned and slightly distant. The solution is a way of enhancing said condition in which stator and permanent magnet poles are aligned closer together in the context of a large motor. The edges of the permanent magnets may be rounded to fit closer to the stator, an already common practice.

The present invention purports to be self-starting. Owing to the design, it is nearly impossible for a permanent magnet pole to be evenly balanced between stator poles. Problem two is addressed in this invention by design and the intended control therein. The controller operates with information of the permanent magnet location. Electromagnetism may be applied to exert force on the permanent magnet in only one direction. A rotor pole cannot be in a balanced position between two attracting forces because there is only one specific localized electromagnetic force intended for each permanent magnet pole of the rotor. Spatial distance in between permanent magnets as well directional field considerations, eliminate such a problem.

These solutions to problems one and two sacrifices a possible asset of previous designs involving a feature wherein a given electromagnetic field is able to attract one permanent magnet pole while repelling another. A certain amount of electricity is used in creating the field, therefore using a given electromagnetic field to attract or repel only one permanent magnet pole implies that the motor is half as efficient. In actuality, an electromagnetism actuating two magnets only increases the period of time that the electromagnet requires current. Problem one shows that there is a certain range of torque angle wherein the electromagnetic force is most effective. Current actuating two rotor poles will be more effective on one pole or the other at a given time. For this reason the efficiency is not doubled by simultaneous attraction and repulsion, and the period of time the current is required in the coil is extended. Therefore, this design is in the interest of problem three as well: if electricity is applied to a given coil for shorter periods of time then there will ultimately be less heat buildup in each coil.

Another approach to the heat problem is dividing the current and workload among more coils. The fact that the rotor poles are spread out and actuated respectively by two different halves of the motor lends to aid the heat problem. This is made possible by the computer controller. Precise control of the motor is required to coordinate the inner and outer coils, and this is also the means by which efficiency is optimized. The computer optimization of efficiency entails that no current is wasted, meaning no unnecessary heat.

It is optimal for a rotor to be as lightweight and sturdy as possible. Problem four indicates a common arrangement of permanent magnets regarding rotors with multiple poles. It is clear, given magnets of the same size and material, an eight-pole rotor design using eight permanent magnets would involve twice the mass as an eight-pole rotor design using four permanent magnets. Accordingly, the present invention allows for utilization of both poles on each permanent magnet.

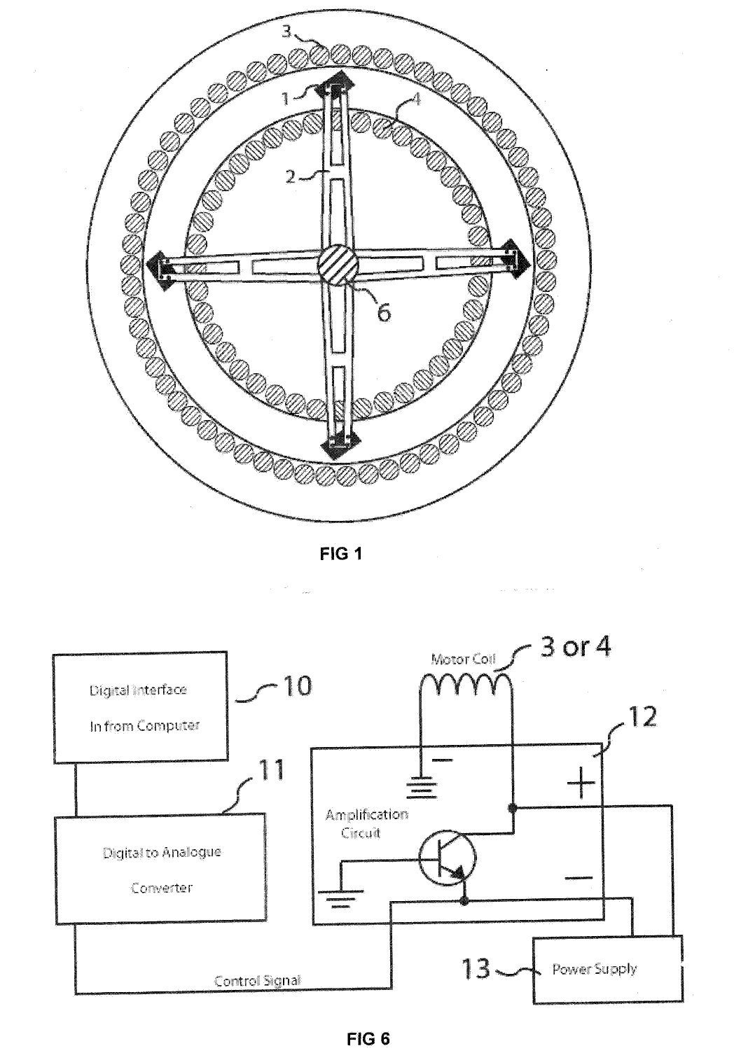

A section through the synchronous motor is represented in FIG. 1. The permanents magnets 1 are affixed to an axle 6 by rotor arms 2. Permanent magnets 1 revolve between external stator coils 3 and internal stator coils 4 represented by shaded circles.

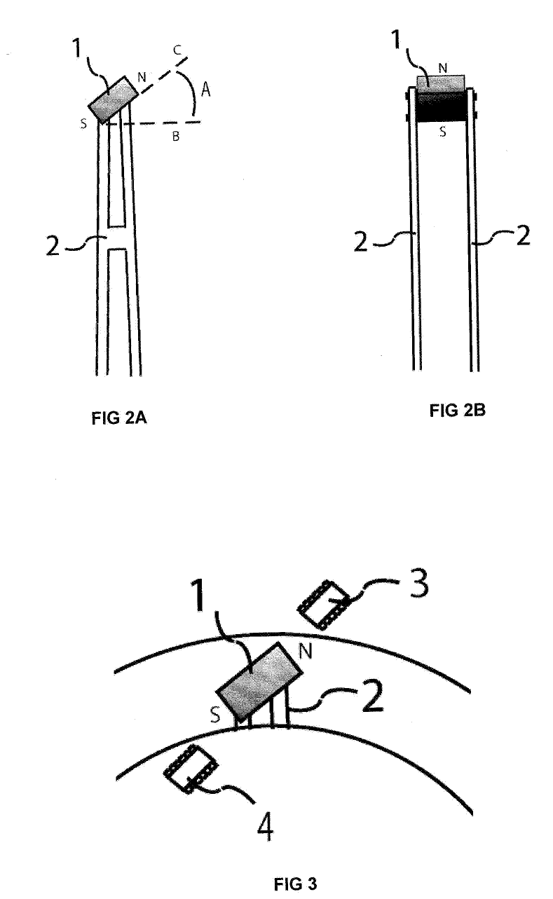

The portion, shown in FIG. 2A, includes a permanent magnet 1 and a rotor arm 2. The permanent magnet 1 is affixed to the rotor arm 2 along line C at an angle A which is approximately 45 degrees from a line B perpendicular to the radius represented by said rotor arm 2. FIG. 2B is a side view at the same portion showing a rotor arm 2 attached to the front and rear of the permanent magnet 1.

The permanent magnet 1 shown in FIG. 3 shows the portion of the motor whereby electromagnetism repels the permanent magnet 1 away from the external stator coil 3 and towards the internal stator coil 4. The rotating permanent magnet 1 provides an indication of the position of the permanent magnet 1.

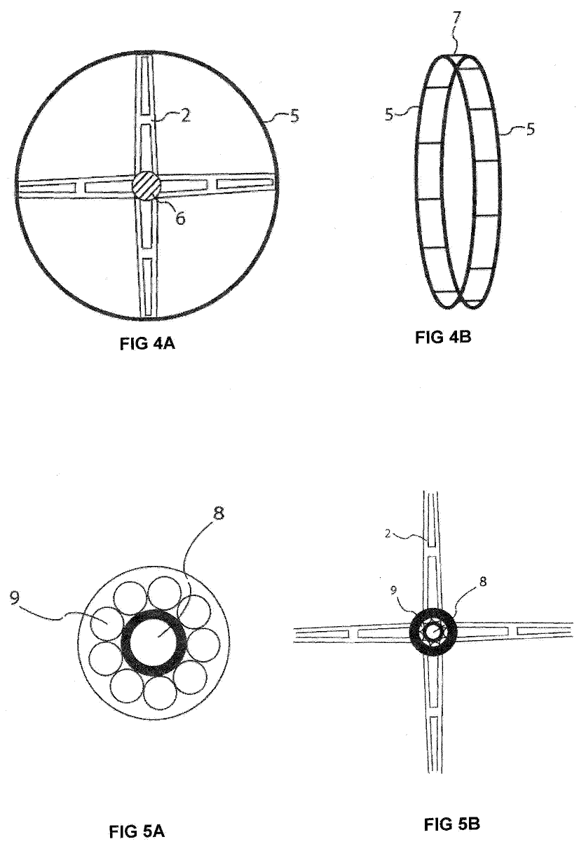

To steady the rotor assembly, the rotor arms 2 are secured by a circumferential reinforcement 5 as in FIG. 4A. The front rotor assembly turns the axle 6. In FIG. 4B the front and rear rotor circumferential reinforcements 5 are affixed together by circumferential reinforcement couplings 7.

The rear rotor assembly axis in FIG. 5A includes a hollow bearing structure 9, the center of which is an electrical conduit 8 to provide power to internal stator coils 4. FIG. 5B shows this bearing 9 affixed to rotor arms 2. Each rotor arm is affixed to a permanent magnet 1 and circumferential reinforcement 5 coupled to the entire front rotor assembly.

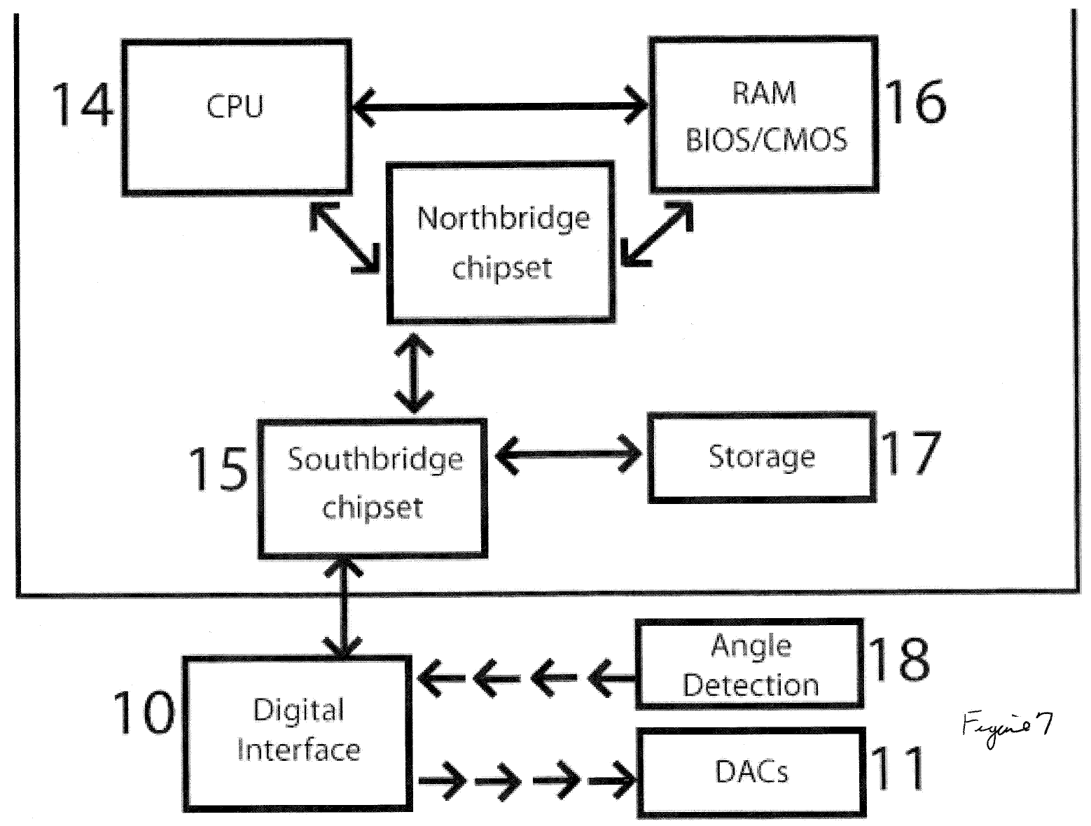

The schematic in FIG. 6 outlines the control circuitry for each stator coil 3 and 4. This represents a plurality of control circuits, all of which engage the same digital interface 10. Digital information is sent to a digital to analogue converter 11 creating a control signal. Amplification circuitry 12 applies electrical power drawn from the power supply 13 to the control signal to provide an amplified signal. The resulting current is then used to power a single stator coil 3 or 4.

FIG. 7 depicts the calculation circuitry, outlining some of the features of a typical computer system. The computer system may include memory 16, 17 to store programs which may be executed by the CPU 14. The Southbridge chipset 15 commonly has interfaces utilizing various protocols, one of which the digital interface 10 also utilizes to link to the computer system.

In operation, a DC brushless synchronous motor and controller circuit detects the rotational angle of the rotor by a detection circuit 18 for detecting a rotational angle of the rotor of the synchronous motor which may include a permanent magnet 1 positioned at any angle relationship with respect to the rotor of the motor. A positional signal is sent by the detection circuit to the digital interface circuit 10 which interfaces with bridge chipsets 15, computer memory 16, 17 and CPU 14, functioning together as a computer system which may analyze the positional signal with algorithms which may be stored in the memory 16 and 17. The calculating circuit computes the control signal and these control signals may be converted from digital to analog by the digital to analog converter circuits 11 thereby generating the control signals. The control signals are amplified by the amplification circuits 12 by employing the power from the power supply circuit 13 thereby generating current vectors that are applied to the motor coils 3, 4 of the synchronous motor drive circuit.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

I claim:

1. A DC brushless synchronous motor and controller, comprising:
a detection circuit for detecting a rotational angle of the rotor of said synchronous motor;
a calculating circuit for calculating data corresponding to a plurality of control signals based upon the rotational angle coupled to said detection circuit;
a control signal generating circuit for generating a plurality of control signals by converting digital information into analogue control signals;
a current vector generating circuit for generating a plurality of current vectors by amplifying said plurality of control signals; and
a synchronous motor drive circuit, wherein each of said plurality of current vectors is applied correspondingly to each stator coil of said motor.

2. A DC brushless synchronous motor and controller as in claim 1, wherein the calculating circuit includes a computer with a program memory having stored therein a computer program in order to facilitate the calculation and transmitting of data.

3. A DC brushless synchronous motor and controller as in claim 1, wherein the control signal generating circuit includes a plurality of digital to analogue conversion circuits to generate the plurality of control signals.

4. A DC brushless synchronous motor and controller as in claim 1, wherein the calculating circuit includes a data interface for communicating data to a plurality of digital to analogue converters.

5. A DC brushless synchronous motor and controller as in claim 1, wherein the current vector generating circuit includes a plurality of amplification circuitry to generate the plurality of current vectors based upon the control signals.

6. A DC brushless synchronous motor and controller as in claim 1, wherein the synchronous motor drive circuit includes a rotor being affixed to a plurality of permanent magnets by rotating along a circular path.

7. A DC brushless synchronous motor and controller as in claim 6, wherein the permanent magnets travel along an exterior of internal stator coils and along an interior of external stator coils.

8. A DC brushless synchronous motor and controller as in claim 6, wherein each of a plurality of permanent magnets includes a magnetic pole actuated by internal stator coils and an opposing magnetic pole actuated by external stator coils.

9. A DC brushless synchronous motor and controller as in claim 1, wherein the current vector supplies an internal stator coil.
